(19) United States
(12) Patent Application Publication
(10) Pub. No.: US 2007/0168973 A1
(43) Pub. Date: Jul. 19, 2007

(54) Method and apparatus for API testing

(75) Inventor: Randall E. Crihfield, Pepperell, MA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/292,592

(22) Filed: Dec. 2, 2005

(51) Int. Cl. G06F 9/44

(52) U.S. Cl. 717/124

(57) ABSTRACT

In general, in one aspect of the invention, the invention relates to a method and system for automatically developing software tests for a software program having source code written in an object-oriented programming language. Computer implemented instructions are stored collectively within the at least one storage device which when executed, perform a method. The method includes determining at least one class present within the source code and identifying a method associated with the class, the method having at least one characteristic. The at least one characteristic includes at least one selected from the group consisting of a category and a number of arguments. The method further includes matching a test template to the method based on the method category and the number of arguments, resulting in a matched template, and generating a test based on the matched template and the method.

### BACKGROUND

As the computing systems have matured, so have the software applications running on those computing systems. Even the simplest software application may include several hundred lines of source code. Complex software applications, such as for operating systems, may include hundreds of thousands of lines of source code.

Modern software applications are often written in object-oriented programming languages. In order to facilitate ease of programming, these software applications often include application program interfaces (API's) which provide routines, protocols, and tools which may be used by application programmers to perform required actions.

Due to the complexity of modern day software, in that a software application may have between a few hundred and many thousands of lines of source code, ensuring the correctness of the source code defining the application has become a very difficult problem to solve.

The testing of software generally takes one of two forms. In the first form, source code is compiled into executable software, and the executable software provided to beta testers who test the code in various possible situations to determine whether the compiled software is working properly. In the second form, programmers who generate the application software source code pass that source code on to test developers who examine each routine within the source code in order to understand how to develop one or more tests to ensure that those routines are operating properly. Those test developers then develop software tests which, when performed, provide insight into whether the software source will work as intended.

### SUMMARY

In general, in one aspect of the invention, the invention relates to a method for automatically developing software tests for a software program having source code written in an object-oriented programming language. The method includes determining at least one class present within the source code and identifying a method associated with the class, the method having at least one characteristic. The at least one characteristic includes at least one selected from the group consisting of a category and a number of arguments. The method further includes matching a test template to the method based on the method category and the number of arguments, resulting in a matched template, and generating a test based on the matched template and the method.

In general, in one aspect of the invention, the invention relates to a system for automatically developing software tests for a software program having source code written in an object-oriented programming language. The system includes a processor and at least one storage device. Computer implemented instructions are stored collectively within the at least one storage device which when executed, perform a method. The method includes determining at least one class present within the source code. Further, a method associated with the class is determined, the method having at least one characteristic. The at least one characteristic includes at least one selected from the group consisting of a category and a number of arguments. The method further includes matching a test template to the method based on the function category and the number of arguments, resulting in a matched template, and generating a test based on the matched template and the method.

Other aspects of the invention will be apparent from the following description and the appended claims.

### BRIEF DESCRIPTION OF DRAWINGS

FIG. 1 shows a block diagram according to one or more embodiments of the invention.

FIG. 2 and FIG. 3 show flowcharts of a method according to one or more embodiments of the present invention.

### DETAILED DESCRIPTION

Exemplary embodiments of the invention will be described with reference to the accompanying drawings. Like items in the drawings are shown with the same reference numbers.

In an embodiment of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating this description.

In general, embodiments of the invention relate to a method and apparatus for automatically generating test program code which tests for proper functionality of source code.

More particularly, in one aspect of the invention, a method for automatically developing software tests for a software program having source code written in an object-oriented programming language includes determining at least one class present within the source code. Further, a method associated with the class is identified, the method having at least one characteristic. The at least one characteristic includes at least one selected from the group consisting of a category, and a number of arguments. The method further includes matching a test template to the method based on the function category and the number of arguments, resulting in a matched template, and generating a test based on the matched template and the method.

Generally, software is developed by one or more members of a development team, the size of which is often dictated by the magnitude and scope of the project. In one or more embodiments of the invention, one or more members of the development team develop the software using a corresponding number of development computing systems in communication with one another over a network. In one or more embodiments of the invention, software is developed by a single software developer using a single development computing system optionally connected to a network.

Following the completion of an initial version of a new piece of development software, or following the completion of a modification of previously written development software, the source code for that software is provided as input to automatic test generating software. In some instances, it is desirable to analyze the source code for the development software in its entirety. In other instances, it is desirable to analyze some portions of the source code for the development software while leaving other portions of the source code unanalyzed.

For example, if the development software is completely new and untested, it may be desirable to test the development software in its entirety. Alternatively, if portions of the development software have previously been tested and/or executed, while other portions have been recently modified, it may be desirable to only test the recently modified portions of the development software.

The automatic test generating software may be present on one or more of the development computing systems used to develop the development software, or may alternatively be present on a test generating computing system coupled to one or more of the development computing systems. Finally, the automatic test generating software may be stored in a database and a master file system, and executed by either of a development computing system or a test generating computing system, as desired.

The test generating computing system may be a stand-alone computing system isolated completely from development computing systems, if desired. In this example, the development software may be transported by the one or more development computing systems having the code to be analyzed to a test generating computing system via any reasonable method. Such reasonable methods may include using a USB memory stick to temporarily hold the one or more portions of the development software to be analyzed. Alternatively, the one or more portions of the development software may be temporarily stored on a floppy disk, a compact disk, a DVD, or any other storage medium, to be used to transport the development software between various computing systems being employed.

In one or more embodiments of the invention, the test software is developed using a computer system coupled to a network such as the Internet, a local area network, a wide area network, a combination of different networks, or other computer communication method enabling electronic communication of data. Such a network may be used, among other things, to facilitate communication between two or more computing systems involved with the development and testing of the development software.

In this specification, it is intended that the term “coupled” describe devices (e.g., computing systems) which interact with each other, directly or indirectly. For example, first and second devices that interact with each other through a transmission line between the two devices are directly coupled. Further, first and second devices that have intermediate devices interposed between them, and interact with one another through those intermediate devices, are indirectly coupled. In both situations, the first and second devices are considered coupled.

Communication between the various entities discussed in this disclosure may take place using any reasonable method, and is not limited to communicating using computer systems attached to networks. Further, communication may take place over wired networks and systems, or may alternatively take place using wireless communication. Further, such code may be transferred over communications networks with or without a carrier wave.

Information present in one computer system and needed in a different standalone system may be stored in memory within a computer, or stored or transferred using any suitable computer readable medium, such as hard drives, optical disks, compact disks, magnetic tape, etc.

The automatic test generating software analyzes one or more portions of the development software to determine one or more classes present within that development software. One of those classes is selected for review, and at least one method within the selected class is selected for analysis, so that a test may be generated for that selected method.

The selected method is analyzed to determine any necessary characteristics associated with the selected method. Such characteristics may include, but are not limited to, the number of arguments associated with the selected method, whether there are any arguments to the selected method, whether there is a non-zero number of arguments to the selected method, whether the selected method returns a value, whether the selected method is invoked on the class, whether the selected method is invoked on an instance of the class, whether the selected method is public, whether the selected method is protected, whether the selected method is private, and whether the selected method is allowed to be overridden in a subclass.

Once any necessary characteristics associated with the selected method are determined, at least one of those characteristics is used to select a test template to be used when testing the portion of the development software to be tested. A test template may be associated with one characteristic or may alternatively be associated with multiple characteristics. Thus, for example, a method having no arguments that does not return a value may be best tested using a first template, while a method that may be invoked on the class may be best tested using a second template.

A test template typically includes, but is not limited to, variables which are replaced when converting the selected test template into usable test software.

The test template may further include code to instantiate one or more classes, provide arguments to the selected method, verify return values, as needed, etc.

Once any variables within the test template have been assigned, either through direct replacement into a copied file representing the template, or through use of an information or data file (as desired by system designers), the resulting one or more files (template and data file) may be executed to perform the test.

Such a system may be employed, as previously discussed, using a standalone computing system with one or more processors, or on a computing system connected through a network to other computing systems, as needed.

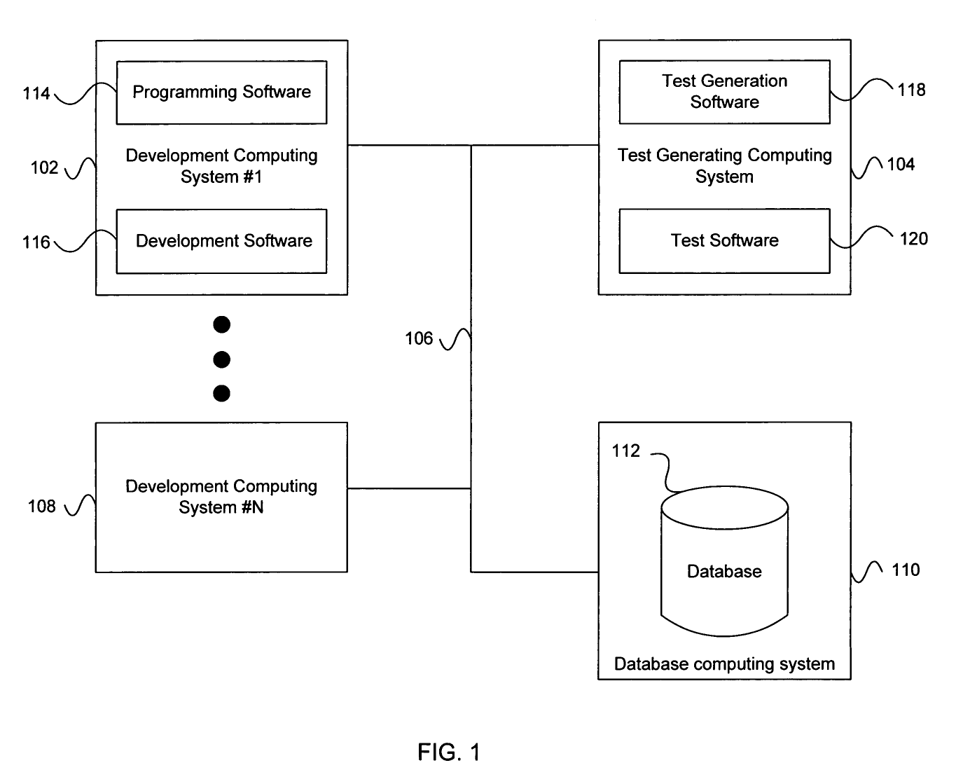

FIG. 1 shows a block diagram according to one or more embodiments of the invention. Development computing system 102 is coupled to test generating computing system 104 through transmission lines 106. Development computing system 102 is provided for the use of software developers (not shown) to write development software. The test code comes from the development software.

Thus, a portion of the development software is used by the test generating computing system 104 to develop one or more software tests to be performed on that portion. In this disclosure, a portion means any piece, however small, up to and including the entirety of the development software.

One or more additional development computing systems, such as development computing system 108, may optionally be connected to development computing system 102 and test generating computing system 104, again through transmission lines 106. Further, database computing system 110 may have stored thereon a database 112 or other storage functionality which may be used as desired for storing development software or test software in a commonly accessible remote location. Persons of ordinary skill in the art having the benefit of this disclosure will readily recognize many different storage means that may be employed to store the development software, the test software, results, etc., while remaining within the scope and purpose of the invention.

Alternatively, any of development computing system 102, development computing system 108, and test generating computing system 104 may be coupled to any one of the other computing systems to wireless or other means. Persons of ordinary skill in the art having the benefit of this disclosure will readily recognize many different ways that computing systems may be connected together while remaining within the scope and purpose of the invention.

Development computing system 102 typically has programming software 114 stored thereon which is used by programmers to generate or modify development software 116. Correspondingly, test generation computing system 104 has test generation software 118 stored thereon which is used by test programmers to generate or modify test software 120. As previously discussed, it is not necessary to have programming software 114 and test generation software 118 installed on different computing systems. Rather, a single computing system may be used for both tasks (i.e., generating or modifying the development software 116, and/or generating or modifying test software 120).

Further, a separate storage area, such as database 112, is not required to be provided. Rather, a storage area may be made available on either of development computing system 102 or test generating computing system 104.

Once the portion(s) of development software are available on the test platform, whether that platform be test generating computing system 104 or a standalone computing system, etc., several activities take place, in order to generate tests and run those tests, as desired.

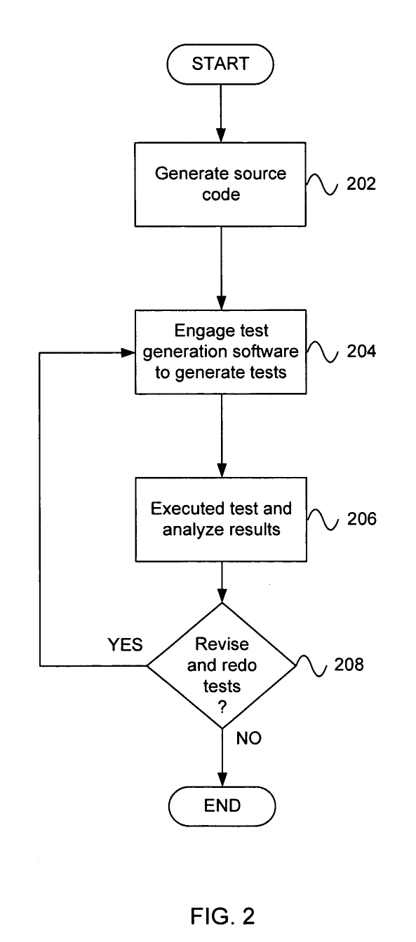

FIG. 2 shows a flowchart according to one or more embodiments of the invention. As previously discussed, a method of the invention begins at 202 when the source code is developed by one or more members of a programming team. This source code is at least a portion of development software 116 (of FIG. 1). In one or more embodiments of the invention the source code is developed in an object-oriented programming language.

At 204, test generation software (such as test generation software 118 (of FIG. 1)) is engaged to generate tests corresponding to the source code generated at 202. At 206, the tests previously generated at 204 are executed, and the results of those tests are analyzed. Persons of ordinary skill in the art having the benefit of this disclosure will readily be aware that the tests executed at 206 may be executed on any properly configured computing system, such as either of test generating computing system 104 (of FIG. 1) or development computing system 102 (of FIG. 1).

At 208, a determination is made whether to revise one or more of the test and redo execution of one or more of the tests. By way of example, if five tests are used, it may be desired to modify test three and only re-execute test three.

Alternatively, if five tests are used, it may be desirable to modify test number three and re-execute tests one, test three, and test four. Finally, if five tests are used, it may be desirable to modify test four and re-execute all five tests.

Persons of ordinary skill in the art having the benefit of this disclosure will readily recognize that any number of tests may be modified and any number of tests may be re-executed, depending on the desires of the test operator.

In order to generate tests relevant to the portions of the development software being tested, one or more classes within the development software are analyzed to determine the one or more methods within those classes. Persons of ordinary skill in the art having the benefit of this disclosure will readily understand that methods present within classes are intended to execute program statements to accomplish specifically delineated tasks.

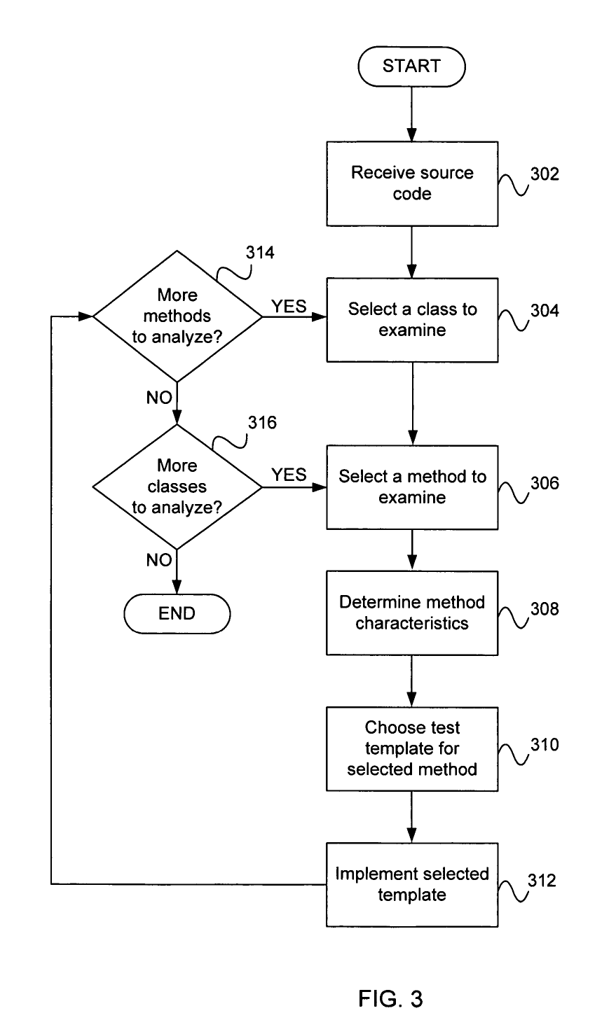

FIG. 3 is a flowchart according to one or more embodiments of the invention. At 302, one or more portions of the development software are received as source code by the test generation software 118 (of FIG. 1).

At 304, a class within a portion of the development software received at 302 is selected for analysis. At 306, a method implemented within the class selected at 304 is chosen for analysis. Persons of ordinary skill in the art having the benefit of this disclosure will readily recognize that object-oriented programs have classes and methods and that the methods typically have characteristics associated with them.

Such method characteristics may include, but are not limited to, the number of arguments associated with the selected method, whether there are any arguments to the selected method, whether there is a nonzero number of arguments to the selected method, whether the selected method returns a value, whether the selected method is invoked on the class, whether the selected method is invoked on an instance of the class, whether the selected method is public, whether the selected method is protected, whether the selected method is private, and whether the selected method is allowed to be overridden in a subclass.

Once any necessary characteristics associated with the selected method are determined at 308, at least one of those characteristics is used to choose a test template to be used to develop tests relevant to the chosen method at 310.

A test template may be associated with one characteristic or may alternatively be associated with multiple characteristics. Thus, for example, a method having no arguments that does not return a value may be best tested using a first template, while a method that may be invoked on the class may be best tested using a different, second template.

A test template typically includes, but is not limited to, variables which are replaced when converting the selected test template into usable test software.

The test template may further include code to instantiate one or more classes, provide arguments to the selected method, verify return values, as needed, etc.

At 312, the template is adjusted to correspond with the particular method chosen at 306. At this time, and variables within the template are assigned values, or alternatively are replaced with values, as desired by system designers.

In one embodiment, values for the variables are supplied using a file external to the template. Once any variables within the test template have been assigned, either through direct replacement into a copied file representing the template, or through use of an information or date file (as desired by system designers), the resulting one or more files (template and data file) may be executed to perform the test.

At 314, a determination is made whether any additional methods exist (from within the class selected at 304) to analyze. If yes, the process proceeds again at 306.

If, at 314, no more methods exist within the class selected at 304 that need analysis, the method proceeds at 316 where a determination whether there are additional classes to examine within the one or more portions of source code of the development software received at 302. If yes, the method proceeds again at 304. If not, the method ends, at which time the test software generated by the method of FIG. 3 may be executed.

One or more of the following advantages may exist by using one or more embodiments of the present invention. A significant savings of manpower that would otherwise be required to generate software based tests for development software. The turnaround time for the test process from start to finish is dramatically decreased, thus allowing systems employing the invention to verify the functionality present within the development software in a much shorter time than would otherwise happen were the tests being developed by hand. Because the turnaround time would be diminished substantially, the cost associated with getting the development software into the hands of users is also minimized.

Although examples of embodiments have been presented in this disclosure herein a computer implements methods, persons of ordinary skill in the art having the benefit of this disclosure will be readily aware that the present invention may be performed on a computer, or may instead be performed manually. Alternatively, portions of the invention may be performed on a computing system, while prior portions are performed without using a computer system.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for automatically developing software tests for a software program having source code written in an object-oriented programming language comprising:
determining at least one class present within the source code;
identifying a method associated with the class, the method having at least one characteristic, wherein the at least one characteristic comprises at least one selected from the group consisting of a method category, and a number of arguments;
matching a test template to the method based on at least one of the method category and the number of arguments, resulting in a matched template; and
generating a test based on the matched template and the method.

2. The method of claim 1 wherein the method category is at least one selected from the group consisting of returns a value, does not return a value, is invoked on the class, is invoked on an instance of the class, is public, is protected, is private, cannot be overridden in a subclass.

3. The method of claim 1 wherein matching the test template to the method based on the number of arguments comprises:
determining a number of arguments associated with the method;
selecting, if the number of arguments is greater than zero, the test template applicable to the method having a nonzero number of arguments; and
selecting, if the number of arguments is equal to zero, the test template applicable to the method having no arguments.

4. The method of claim 1 wherein the test template comprises at least one test variable, and wherein generating the test based on the matched template and the method comprises:
identifying the at least one test variable present in the matched template;
copying the matched template, resulting in a copied template;
replacing the at least one test variable within the copied template with a corresponding number of the characteristics, resulting in the test.

5. The method of claim 1 wherein the test template comprises at least one test variable, and wherein generating the test based on the matched template and the method comprises:
identifying the at least one test variable present in the matched template; and
generating an information file having at least one value to be assigned to the at least one test variable during execution of at least one of the software tests.

6. The method of claim 1 further comprising receiving the source code from at least one development computing system accessible over a network.

7. The method of claim 1 further comprising receiving the source code from at least one database computing system accessible over a network.

8. The method of claim 1 further comprising:
executing the test; and
analyzing the results of the test.

9. A system for automatically developing software tests for a software program having source code written in an object-oriented programming language comprising:
a processor; and
at least one storage device, wherein computer implemented instructions are stored collectively within the at least one storage device which when executed, perform a method comprising:
determining at least one class present within the source code;
determining a method associated with the class, the method having at least one characteristic, wherein the at least one characteristic comprises at least one selected from the group consisting of a method category, and a number of arguments;
matching a test template to the method based on at least one of the method category and the number of arguments, resulting in a matched template; and
generating a test based on the matched template and the method.

10. The system of claim 9 wherein the method category is at least one selected from the group consisting of returns a value, does not return a value, is invoked on the class, is invoked on an instance of the class, is public, is protected, is private, cannot be overridden in a subclass.

11. The system of claim 9 wherein matching a test template to the method based on the number of arguments comprises:
determining a number of arguments associated with the method;
selecting, if the number of arguments is greater than zero, the test template applicable to the method having a nonzero number of arguments; and
selecting, if the number of arguments is equal to zero, the test template applicable to the method having no arguments.

12. The system of claim 9 wherein the test template comprises at least one test variable, and wherein generating the test based on the matched template and the method comprises:
identifying the at least one test variable present in the matched template;
copying the matched template, resulting in a copied template;
replacing the at least one test variable within the copied template with a corresponding number of the characteristics, resulting in the test.

13. The system of claim 9 wherein the test template comprises variables, and wherein generating the test based on the matched template and the method comprises:
identifying the at least one test variable present in the matched template; and
generating an information file having at least one value to be assigned to the at least one test variable during execution of at least one of the software tests.

14. The system of claim 9 wherein the method further comprises receiving the source code from at least one development computing system accessible over a network.

15. The system of claim 9 wherein the method further comprises receiving the source code from at least one database computing system accessible over a network.

16. The system of claim 9 wherein the method further comprises:
executing the test; and
analyzing the results of the test.

17. A computer readable medium having processor executable instructions stored thereon for executing a method comprising:
determining at least one class present within the source code;
identifying a method associated with the class, the method having at least one characteristic, wherein the at least one characteristic comprises at least one selected from the group consisting of a method category, and a number of arguments;
matching a test template to the method based on at least one of the method category and the number of arguments, resulting in a matched template; and
generating a test based on the matched template and the method.

18. The computer readable medium of claim 17 wherein the method category is at least one selected from the group consisting of returns a value, does not return a value, is invoked on the class, is invoked on an instance of the class, is public, is protected, is private, cannot be overridden in a subclass.

19. The computer readable medium of claim 17 wherein the method further comprises:
matching the test template to the method based on the number of arguments comprises:
determining a number of arguments associated with the method;
selecting, if the number of arguments is greater than zero, the test template applicable to the method having a nonzero number of arguments; and
selecting, if the number of arguments is equal to zero, the test template applicable to the method having no arguments.

20. The computer readable medium of claim 17 wherein the test template comprises at least one test variable, and wherein generating the test based on the matched template and the method comprises:
identifying the at least one test variable present in the matched template; and
generating an information file having at least one value to be assigned to the at least one test variable during execution of at least one of the software tests.
